(19) United States
(12) Patent Application Publication
(10) Pub. No.: US 2014/0211693 A1
(43) Pub. Date: Jul. 31, 2014

(54) Transmitter, Receiver, Transmission Method, Control Program of Transmitter, Reception Method, and Control Program of Receiver

(71) Applicant: Kabushiki Kaisha Toshiba, Tokyo (JP)

(72) Inventor: Yoshinobu Fujiwara, Ome-shi (JP)

(73) Assignee: Kabushiki Kaisha Toshiba, Tokyo (JP)

(21) Appl. No.: 14/011,562

(22) Filed: Aug. 27, 2013

Related U.S. Application Data
(63) Continuation of application No. PCT/JP2013/058415, filed on Mar. 22, 2013.

(30) Foreign Application Priority Data
Jan. 31, 2013 (JP) 2013-017903

(51) Int. Cl. H04W 24/02

(52) U.S. Cl. CPC H04W 24/02
USPC 370/328

(57) ABSTRACT

According to one embodiment, transmitter includes, instruction receiving module, network detection module and request command output module. The instruction receiving module configured to receive instruction to transmit recorded content to receiver connected via network. The network detection module configured to detect, by using connection information to network of receiver, whether receiver is inside home-network that the local device belongs to. The request command output module configured to output first request command to receiver when receiver is in home-network, and configured to output second request command to receiver when receiver is not in the home network.

### CROSS REFERENCE TO RELATED APPLICATIONS

This application is a Continuation Application of PCT Application No. PCT/JP2013/058415, filed Mar. 22, 2013 and based upon and claiming the benefit of priority from Japanese Patent Application No. 2013-017903, filed Jan. 31, 2013, the entire contents of all of which are incorporated herein by reference.

### FIELD

Embodiments described herein relate generally to a transmitter, a receiver, a transmission method, a control program of transmitter, a reception method, and a control program of receiver.

### BACKGROUND

In recent years, for example, between devices connected through a network (e.g. a transmitter (source) and a receiver (sink)), dubbing of content has become possible.

When dubbing (moving and copying) of copyright-protected content (e.g. content that is broadcast by terrestrial digital broadcasting or the like) is carried out between devices connected via an IP network, a content protection technology that is compliant with a DTCP-IP (Digital Transmission Content Protection over Internet Protocol) standard is used, for example.

However, for example, when the transmitter (source) is in a home network, and the receiver (sink) is not in the home network (outside the home network), the dubbing of content might fail, causing inconvenience to a user.

Therefore, a challenge is to reduce the odds of content-dubbing failures, which might occur when the transmitter (source) and the receiver (sink) are in different home networks, and to improve convenience of a user.

A challenge is to reduce the odds of content-dubbing failures, which might occur when the transmitter (source) and the receiver (sink) are in different home networks, and to improve convenience of a user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a diagram showing how dubbing of content is carried out when a transmitter (source) and receiver (sink) of an embodiment are in different home networks according to an embodiment;

FIG. 2 shows an example of a diagram showing how dubbing of content is carried out when a transmitter (source) and receiver (sink) of an embodiment are in the same home network according to an embodiment;

FIG. 3 shows an example of an operation between a transmitter (source) and a receiver (sink) according to an embodiment; and

FIG. 4 shows an example of an operation of a transmitter (source) and a receiver (sink) according to an embodiment.

### DETAILED DESCRIPTION

Various embodiments will be described hereinafter with reference to the accompanying drawings.

In general, according to one embodiment, a transmitter comprises: an instruction receiving module, a network detection module and a request command output module. The instruction receiving module configured to receive an instruction to transmit recorded content to a receiver connected via a network. The network detection module configured to detect, by using connection information to the network of the receiver, whether the receiver is inside a home network that the local device belongs to. The request command output module configured to output a first request command to the receiver when the receiver is in the home network, and configured to output a second request command to the receiver when the receiver is not in the home network.

Among the copyright protection technologies for home networks is DTCP-IP.

DTCP (Digital Transmission Content Protection) is a technique used for copy protection in a home network/personal network.

Among DTCPs, DTCP-IP is used together with DLNA (Digital Living Network Alliance), and is used mainly for video distribution of terrestrial digital/BS digital/CS digital that ban content from being copied three times at home.

For example, DLNA is an industry organization founded to make it easier to connect together devices of different manufacturers, such as consumer electronics, mobile equipment, and personal computers.

As Move of DTCP-IP, Transaction Based Move is defined.

In the latest version of DTCP-IP, remote access specifications are set.

In this case, as for dubbing, a device (transmitter, Source) that holds content is operated, and a move-destination device (receiver, Sink) is specified, and Move is carried out. The operation is referred to as “Upload Move.”

The “Upload Move” is carried out by the following procedure.

1. A transmitter (Source) asks a receiver (Sink) to request an AKE process (Authentication and Key Exchange) for DTCP-IP Move.

2. The receiver (Sink) requests the transmitter (Source) to perform the AKE process for DTCP-IP Move.

3. The transmitter (Source) and the receiver (Sink) perform the AKE process for DTCP-IP Move, and share a secret key.

4. The transmitter (Source) and the receiver (Sink) use the secret key to transmit content.

When “Upload Move” is carried out between the transmitter (Source) that is in a home network and the receiver (Sink) that is outside the home network, the process can be carried out normally until the above step 2.

However, at the above step 3, the receiver (Sink) requests the AKE process for DTCP-IP Move, which is used in the home network.

Accordingly, the transmitter (Source) attempts to perform the AKE process for DTCP-IP Move in the home network. Therefore fails as a result.

For example, if the receiver (Sink) requests an AKE process for DTCP-IP Move that is used for remote access, the above step 3 would succeed.

However, the receiver (Sink) cannot determine, at the above step 2, whether a device (receiver (Sink)) that is to be requested to perform the AKE process for DTCP-IP Move is inside the home network or outside the home network.

That is, in this case, since it is the transmitter (Source) that requests the first connection, the transmitter (Source) can detect whether the other device (receiver (Sink)) is inside the home network to which the transmitter (Source) belongs (or where the transmitter (Source) is placed), or outside the home network to which the transmitter (Source) belongs (or where the transmitter (Source) is placed). However, the receiver (Sink) cannot detect.

Therefore, according to the present embodiment, at the above step 1, notification is issued as to whether the “AKE is for DTCP-IP Move that is used in the home network” or “is for DTCP-IP Move that is used for remote access.”

Then, the receiver (Sink) can determine which AKE process to request by using the notified information (about whether “AKE is for DTCP-IP Move that is used in the home network” or “is for DTCP-IP Move that is used for remote access”).

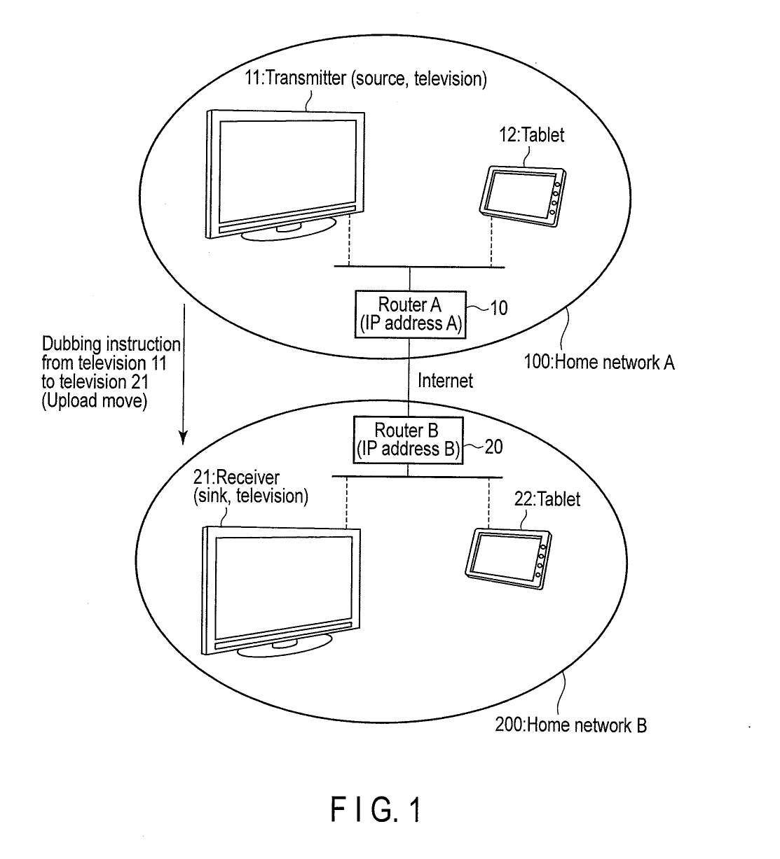

FIG. 1 is a diagram showing how dubbing of content is carried out when a transmitter (source) and receiver (sink) of the embodiment are in different home networks.

As shown in FIG. 1, in this case, a transmitter (source) 11, a tablet 12, and the like are configured inside a home network A100 in a home. The transmitter (source) 11, for example, is an electronic device, such as a television, which is connected to a recording medium not shown in the diagram. For example, content, such as video or music, is stored (recorded) in the recording medium.

A receiver (sink) 21, a tablet 22, and the like are configured inside a home network B200. The home network B200, for example, is built in a remote, different home.

For example, the receiver (sink) 21 of the home network B200 is an electronic device, such as a television, which is connected to a recording medium not shown in the diagram, and can store (record) content such as video or music that is transmitted from the transmitter (source) 11.

That is, in this case, the home network A100 in which the transmitter (source) 11 is configured is different from the home network B200 in which the receiver (sink) 21 is configured.

For example, the home network A100 and the home network B200 are connected through the Internet or the like via routers A10 and B20, as shown in FIG. 1.

For example, an IP address of the router A10 is “IP address A,” and an IP address of the router B20 is “IP address B.”

For example, the transmitter (source) 11 can acquire IP address information (“IP address B” and the like) of the router B20. As described later, the transmitter (source) 11 can detect, by using the IP address information (“IP address B” and the like), whether the receiver (sink) 21 of the home network B200 is in the same home network (home network A100) as that of the transmitter (source) 11.

In this case, content that is stored (recorded) in the recording medium is transmitted from the transmitter (source) 11 to the receiver (sink) 21, and a storing (recording), i.e. dubbing, of the content is carried out.

According to the present embodiment, the transmitter (source) 11 includes an instruction receiving module that receives an instruction to transmit the recorded content to the receiver (sink) 21 that is connected via the network.

Moreover, a network detection module that detects, by using connection information (IP address information (“IP address B” and the like)) to the network of the receiver (sink) 21, whether the receiver is inside the home network that the local device belongs to.

Moreover, a request command output module that outputs a first request command to the receiver (sink) 21 when the receiver (sink) 21 is in the same home network as the transmitter (source) 11 is, and outputs a second request command to the receiver (sink) 21 when the receiver (sink) 21 is not in the same home network as the transmitter (source) 11 is.

That is, according to the present embodiment, for example, in DTCP-IP Remote Access, DTCP-IP Transaction Based Move is used to carry out dubbing (Upload Move).

If a dubbing destination (receiver (sink) 21) is outside the home network of the receiver (sink) 21, the transmitter (source) 11 notifies a receiving apparatus (receiver (sink) 21) of a flag (flag) indicating that “RA-AKE is carried out,” for example.

In this case, the home networks are LAN environments of a communication system, such as personal computers (PCs) built in a home, for example.

For example, routers, hubs, and the like are placed, and Ethernet (Registered Trademark) cables are connected; Internet connection and sharing of printers, files, and the like are therefore possible.

Moreover, for example, by using PCs equipped with wireless LAN, routers, access points, and the like, personal computer (PC), printers, and the like can be connected without using cables.

Not only are AV devices such as video and audio connected to a network, but also home appliances such as refrigerators and microwave ovens can be increasingly connected to a network (information appliances). By building a home network, connection to such information appliances becomes possible.

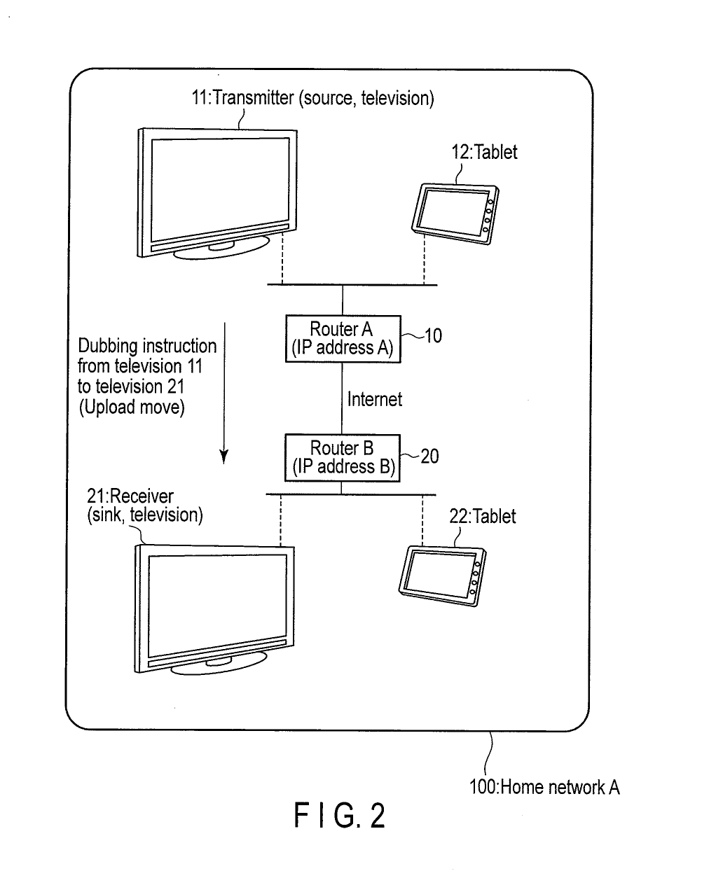

FIG. 2 is a diagram showing how dubbing of content is carried out when a transmitter (source) and receiver (sink) of the embodiment are in the same home network.

As shown in FIG. 2, in this case, a transmitter (source) 11, a tablet 12, and the like are configured inside a home network A100 in a home.

A receiver (sink) 21, a tablet 22, and the like, too, are configured inside the same home network A100 for the transmitter (source) 11.

In this case, for example, the transmitter (source) 11 and the receiver (sink) 21 are connected via routers A10 and B20.

Incidentally, in this case, for example, the router A10 or B20 may be omitted.

As in the case described above, for example, an IP address of the router A10 is “IP address A,” and an IP address of the router B20 is “IP address B.”

For example, the transmitter (source) 11 can acquire IP address information (“IP address B” and the like) of the router B20. The transmitter (source) 11 can detect, by using the IP address information (“IP address B” and the like), whether the receiver (sink) 21 is in the same home network (home network A100) as that of the transmitter (source) 11.

As in the case described above, content that is stored (recorded) in the recording medium is transmitted from the transmitter (source) 11 to the receiver (sink) 21, and a storing (recording), i.e. dubbing, of the content is carried out.

According to the present embodiment, the transmitter (source) 11 includes an instruction receiving module that receives an instruction to transmit the recorded content to the receiver (sink) 21 that is connected via the network.

Moreover, the transmitter (source) 11 includes a network detection module that detects, by using connection information (IP address information (“IP address B” and the like)) to the network of the receiver (sink) 21, whether the receiver is inside the home network that the local device belongs to.

Moreover, the transmitter (source) 11 includes a request command output module that outputs a first request command to the receiver (sink) 21 when the receiver (sink) 21 is in the same home network as the transmitter (source) 11 is, and outputs a second request command to the receiver (sink) 21 when the receiver (sink) 21 is not in the same home network as the transmitter (source) 11 is.

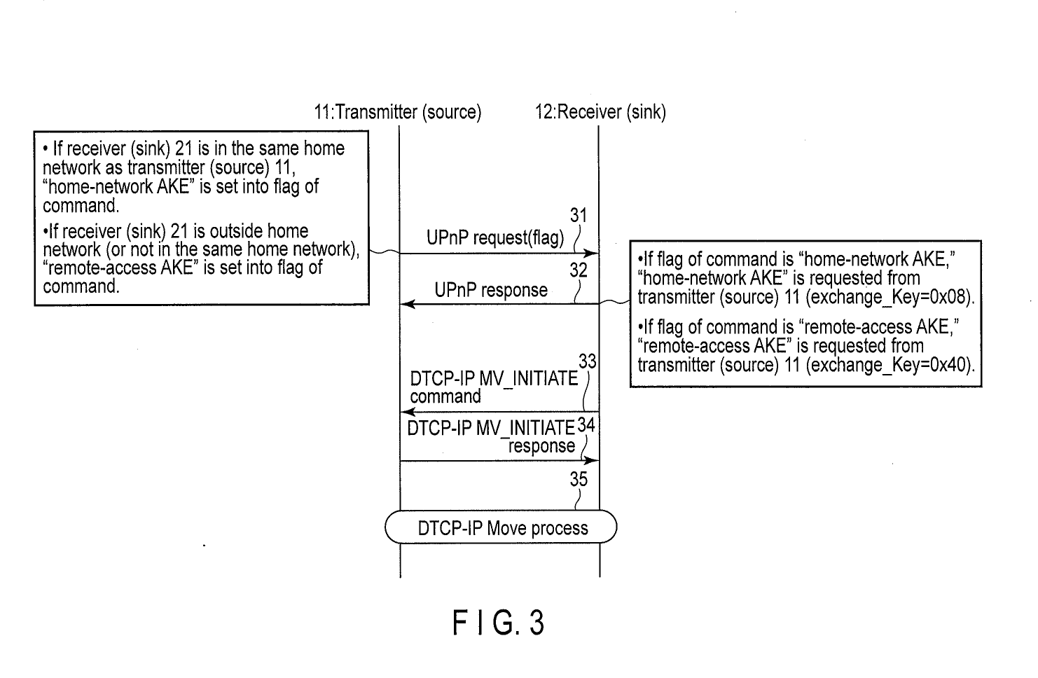

FIG. 3 is a flowchart showing operation of the transmitter (source) and receiver (sink) of the embodiment.

As shown in FIG. 3, in this case, content that is recorded on the side of the transmitter (source) 11 is transmitted to the receiver (sink) 12 that is connected via the network, and the content is recorded.

Then, the transmitter (source) 11 transmits an “UPnP request (flag)” to the receiver (sink) 21.

In this case, if the receiver (sink) 21 is in the same home network as the transmitter (source) 11 is, a “home-network AKE” is set into the flag of the command.

If the receiver (sink) 21 is not in the same home network (or is outside the home network), a “remote-access AKE” is set into the flag of the command.

UPnP (Universal Plug and Play) is technical specifications for connecting home personal computers, peripheral devices, and devices such as AV devices, telephones, and home appliances, through a network, allowing the devices to provide functions to each other.

Then, the receiver (sink) 21 transmits, to the transmitter (source) 11, an “UPnP response.”

If the flag of the command is “home-network AKE,” requests a “home-network AKE” from the transmitter (source) 11 (e.g. exchange_Key=0x08).

If the flag of the command is “remote-access AKE,” requests a “remote-access AKE” from the transmitter (source) 11 (e.g. exchange_Key=0x40).

Then, the receiver (sink) 21 transmits, to the transmitter (source) 11, a “DTCP-IP MV_INITIATE command.”

Then, the transmitter (source) 11 transmits, to the receiver (sink) 21, a “DTCP-IP MV_INITIATE response.”

Then, in order to carry out dubbing from the transmitter (source) 11 to the receiver (sink) 12, a “DTCP-IP Move process” is performed.

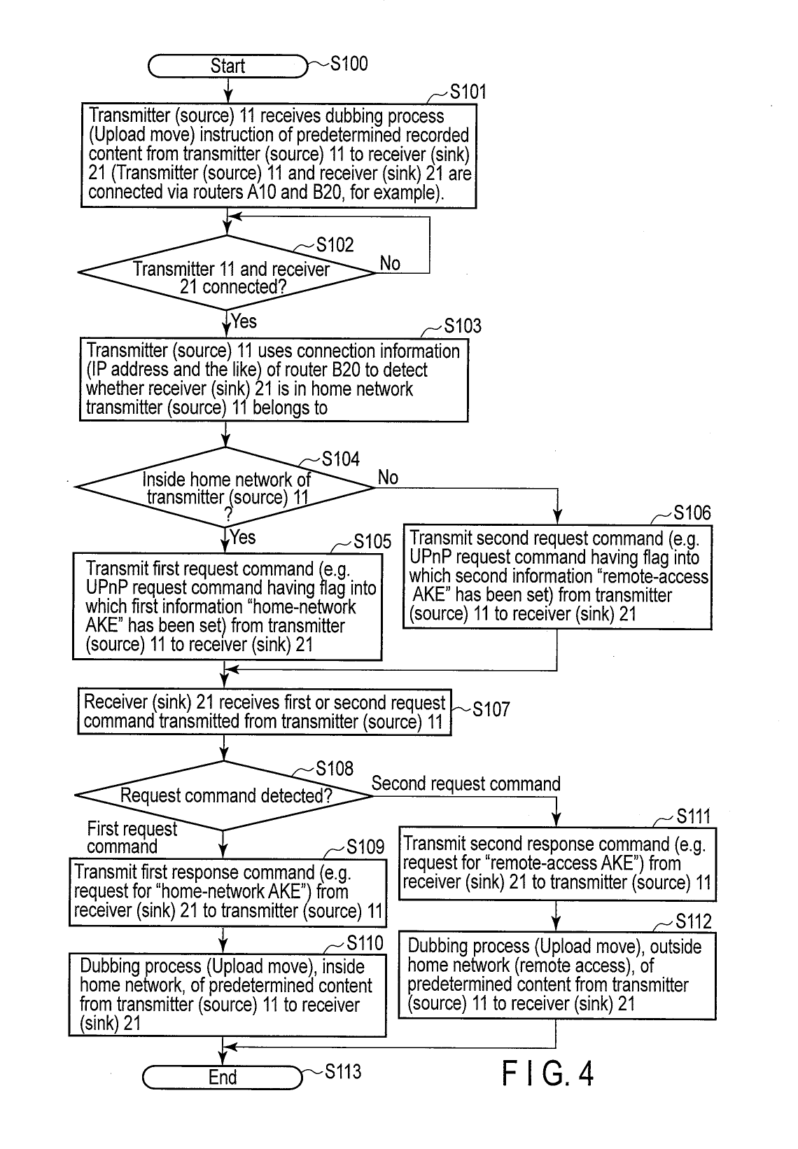

FIG. 4 is a flowchart showing operation of the transmitter (source) and receiver (sink) of the embodiment.

Step S100 is a start step in this case. The process then proceeds to step S101.

Step S101 is a step at which the transmitter (source) 11 receives a dubbing process (Upload Move) instruction of a predetermined recoding content from the transmitter (source) 11 to the receiver (sink) 21.

In this case, for example, the transmitter (source) 11 and the receiver (sink) 21 are connected via the routers A10 and B20. Then, the process proceeds to step S102.

For example, step S102 is a step of detecting whether the transmitter 11 and the receiver 21 are connected. If it is detected that the transmitter 11 and the receiver 21 are connected, the process proceeds to step S103 (Yes). If it is detected that the transmitter 11 and the receiver 21 are not connected, the step is repeated (No).

Step S103 is a step at which the transmitter (source) 11 detects, by using connection information (IP address and the like) of the router B20, whether the receiver (sink) 21 is inside the home network that the transmitter (source) 11 belongs to. Then, the process proceeds to step S104.

Step S104 is a step of detecting whether the receiver (sink) 21 is inside the home network (home network A100) of the transmitter (source) 11.

If it is detected that the receiver (sink) 21 is inside the home network (home network A100) of the transmitter (source) 11, the process proceeds to step S105 (Yes). If it is detected that the receiver (sink) 21 is not inside the home network (home network A100) of the transmitter (source) 11, the process proceeds to step S106 (No).

Step S105 is a step of transmitting a first request command (e.g. an UPnP request command having a flag into which first information “home-network AKE” has been set) from the transmitter (source) 11 to the receiver (sink) 21. Then, the process proceeds to step S107.

Step S106 is a step of transmitting a second request command (e.g. an UPnP request command having a flag into which second information “remote-access AKE” has been set) from the transmitter (source) 11 to the receiver (sink) 21. Then, the process proceeds to step S107.

Step S107 is a step at which the receiver (sink) 21 receives the first or second request command transmitted from the transmitter (source) 11. Then, the process proceeds to step S108.

Step S108 is a step of detecting the request command (the first or second request command). If the first request command is detected, the process proceeds to step S109 (first request command).

For example, if a special mention is not made in the first request command, or if no mention is made in the first request command, the receiver (sink) 21 may be so configured as to detect that the home-network AKE has been requested.

If the second request command is detected, the process proceeds to step S111 (second request command).

Step S109 is a step of transmitting a first response command (e.g. a request for “home-network AKE” from the receiver (sink) 21 to the transmitter (source) 11.

Then, the process proceeds to step S110.

Step S110 is a step of carrying out, inside the home network, a dubbing process (Upload Move) of predetermined content from the transmitter (source) 11 to the receiver (sink) 21. Then, the process proceeds to step S113.

Step S111 is a step of transmitting a second response command (e.g. a request for “remote-access AKE”) from the receiver (sink) 21 to the transmitter (source) 11. Then, the process proceeds to step S112.

Step S112 is a step of carrying out, outside the home network (remote access), a dubbing process (Upload Move) of predetermined content from the transmitter (source) 11 to the receiver (sink) 21. Then, the process proceeds to step S113.

Step S113 is an end step, where the process comes to an end.

That is, according to the present embodiment, the transmitter (source) 11 includes an instruction receiving module that receives an instruction to transmit the recorded content to the receiver (sink) 21 that is connected via the network.

Moreover, the transmitter (source) 11 includes a network detection module that detects, by using connection information to the network of the receiver (sink) 21, whether the receiver (sink) 21 is inside the home network that the local device (transmitter (source) 11) belongs to.

Moreover, the transmitter (source) 11 includes a request command output module that outputs the first request command to the receiver (sink) 21 when the receiver (sink) 21 is in the above home network, and outputs the second request command to the receiver (sink) 21 when the receiver (sink) 21 is not in the above home network.

Into the flag of the first request command, the first information is set. Into the flag of the second request command, the second information is set.

The first information is home-network AKE, and the second information is remote-access AKE.

The connection information to the network contains an IP address of a router to which the receiver (sink) 21 is connected.

According to the present embodiment, in the receiver (sink) 21 that receives the recorded content from the transmitter (source) 11 that is connected via the network, and records the content, a request command receiving module is provided to receive the first or second request command transmitted from the transmitter (source) 11.

Moreover, a response command transmitting module is provided to transmit the first response command to the transmitter (source) 11 when the first request command is received, and transmit the second response command to the transmitter (source) 11 when the second request command is received.

The first response command is a request for home-network AKE. The second request command is remote-access AKE.

That is, according to the present embodiment, for example, at the above step 1, the transmitter (source) 11 may prepare the “flags” described below for “SOAP request of UPnP.”

That is, “flag”=0: AKE used in the home network. “flag”=1: AKE used for remote access.

The transmitter (source) 11 appropriately sets the “flag,” and notifies the receiver (sink) 21 of the flag.

If the “flag”=0, the receiver (sink) 21 sets exchange_keyfield into 0x08 (00001000); if the “flag”=1, the receiver (sink) 21 sets exchange_key field into 0x40 (01000000) (V1SE.5.4.3, V1SE.5.2). Then, the receiver (sink) 21 transmits MV_INITIATE command (V1SE.10.4.1).

According to another embodiment, for DTCP.COM_FLAGS (V1SE.12.8.1) of the DTCP-IP specification document and res@dtcp:uploadInfo (V1SE.12.8.2), the above “flag” may be prepared.

For example, when described in the actual specification document, the following description is made:

Bit 28 colon RA-AKE is required

Bit 28 is set to one if Remote Access AKE is required.

Therefore, it is possible to solve the problem that arises when the above Move is performed.

Because of the above configuration, according to the present embodiment, it is possible to reduce the odds of content-dubbing failures, which might occur when the transmitter (source) and the receiver (sink) are in different home networks, and to improve convenience of a user.

Incidentally, all the procedures of the control process of the above embodiment can be performed by software. Therefore, if a program that is designed to perform the procedures of the control process is installed and executed on a normal computer through a computer-readable storage medium in which the program is stored, the same advantageous effects as those of the above embodiment can be easily achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmitter comprising:
an instruction receiving module configured to receive an instruction to transmit recorded content to a receiver connected via a network;
a network detection module configured to detect, by using connection information to the network of the receiver, whether the receiver is inside a home network that the local device belongs to; and
a request command output module configured to output a first request command to the receiver when the receiver is in the home network, and configured to output a second request command to the receiver when the receiver is not in the home network.

2. The transmitter of claim 1, wherein into a flag of the first request command, first information is set, and into a flag of the second request command, second information is set.

3. The transmitter of claim 2, wherein the first information is home-network AKE, and the second information is remote-access AKE.

4. The transmitter of claim 2, wherein the connection information to the network contains an IP address of a router to which the receiver is connected.

5. A receiver configured to receive recorded content from a transmitter connected via a network and records the content, the receiver comprising:
a request command receiving module configured to receive a first or second request command transmitted from the transmitter; and
a response command transmitting module configured to transmit a request for a home-network AKE of a first response command to the transmitter when the first request command is received, and configured to transmit a request for a remote-network AKE of a second response command to the transmitter when the second request command is received.

6. The receiver of claim 5, wherein if a special mention is not made in the first request command, it is detected that home-network AKE has been requested.

7. A transmission method comprising:
receiving an instruction to transmit recorded content to a receiver that is connected via a network;
detecting, by using connection information to the network of the receiver, whether the receiver is inside a home network that a local device belongs to; and
outputting a first request command to the receiver when the receiver is in the home network, and outputting a second request command to the receiver when the receiver is not in the home network.

8. A non-transitory computer readable medium having stored thereon a computer program which is executable by a computer, the computer program controlling the computer for controlling a transmission with a transmitter to execute functions of:
receiving an instruction to transmit recorded content to a receiver that is connected via a network;
detecting, by using connection information to the network of the receiver, whether the receiver is inside a home network that a local device belongs to; and
outputting a first request command to the receiver when the receiver is in the home network, and outputting a second request command to the receiver when the receiver is not in the home network.

9. A reception method by which recorded content is received from a transmitter that is connected via a network and the content is recorded, comprising:
receiving a first or second request command transmitted from the transmitter; and
transmitting a request for a home-network AKE of a first response command to the transmitter when the first request command is received, and transmitting a request for a remote-network AKE of a second response command to the transmitter when the second request command is received.

10. A non-transitory computer readable medium having stored thereon a computer program which is executable by a computer, the computer program controlling the computer for controlling a reception with a receiver to execute functions of:
receiving a first or second request command transmitted from the transmitter; and
transmitting a request for a home-network AKE of a first response command to the transmitter when the first request command is received, and transmitting a request for a remote-network AKE of a second response command to the transmitter when the second request command is received.

11. The reception method of claim 9, wherein if a special mention is not made in the first request command, or if no mention is made in the first request command, the receiver may be so configured as to detect that the home-network AKE has been requested.

12. The computer program of claim 10, further comprising:
if a special mention is not made in the first request command, or if no mention is made in the first request command, the receiver may be so configured as to detect that the home-network AKE has been requested.
